(19) United States
(12) Patent Application Publication
(10) Pub. No.: US 2018/0320662 A1
(43) Pub. Date: Nov. 8, 2018

(54) Windmill Rotation Restrictor Device

(71) Applicant: Mark Buysse, Minneota, MN (US)

(72) Inventor: Mark Buysse, Minneota, MN (US)

(21) Appl. No.: 15/590,002

(22) Filed: May 8, 2017

(51) Int. Cl. F03D 7/02; F03D 13/20; F03D 15/00; F03D 1/06; F03D 1/04

(52) U.S. Cl. CPC F03D 7/0248; F03D 13/20; F05B 2260/4031; F03D 1/06; F03D 1/04; F03D 15/00

(57) ABSTRACT

A windmill rotation restrictor device restricts the speed of rotation of front blades of a decorative windmill in high winds. The device includes a windmill having a base, a rotor, and a vane. The rotor includes a front blade assembly and a front shaft extending from the front blade assembly. The front shaft is freely rotatable relative to the base. The vane includes a rear blade assembly and a rear shaft extending from the rear blade assembly. The rear shaft is freely rotatable relative to the base. The front blade assembly and the rear blade assembly rotate in opposite directions when blown by wind from a single direction. A linkage couples the front shaft to the rear shaft such that rotation of the rear blade assembly counteracts and slows rotation of the front blade assembly.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

[symbol]

### (2) Description of Related Art Including Information Disclosed Under 37 CFR 1.97 and 1.98

The disclosure and prior art relates to rotation restrictor devices and more particularly pertains to a new rotation restrictor device for restricting the speed of rotation of front blades of a decorative windmill in high winds.

### BRIEF SUMMARY OF THE INVENTION

An embodiment of the disclosure meets the needs presented above by generally comprising a windmill having a base, a rotor, and a vane. The rotor includes a front blade assembly and a front shaft extending from the front blade assembly. The front shaft is freely rotatable relative to the base. The vane includes a rear blade assembly and a rear shaft extending from the rear blade assembly. The rear shaft is freely rotatable relative to the base. The front blade assembly and the rear blade assembly rotate in opposite directions when blown by wind from a single direction. A linkage couples the front shaft to the rear shaft such that wind pressure on the rear blade assembly counteracts and slows rotation of the front blade assembly.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top rear side perspective view of a windmill rotation restrictor device according to an embodiment of the disclosure.

FIG. 2 is a top rear perspective detailed view of a linkage of an embodiment of the disclosure.

FIG. 3 is a side view of an embodiment of the disclosure.

FIG. 4 is a cross-sectional view of an embodiment of the disclosure taken along line 4-4 of FIG. 3.

FIG. 5 is a side view of an embodiment of the disclosure in use.

### DETAILED DESCRIPTION OF THE INVENTION

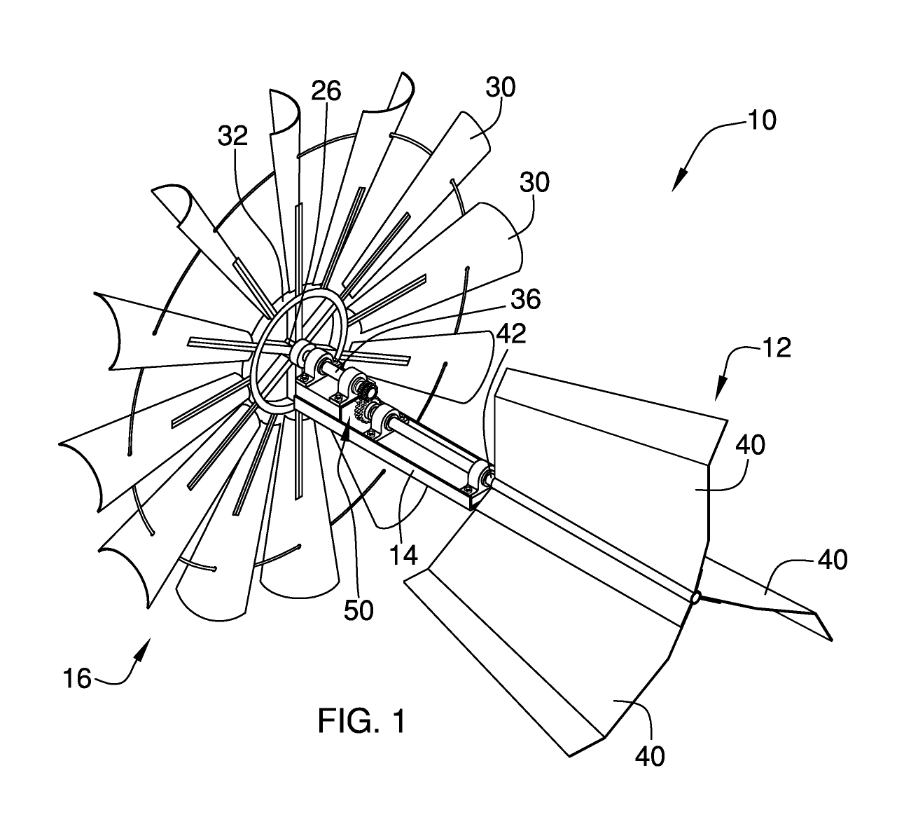

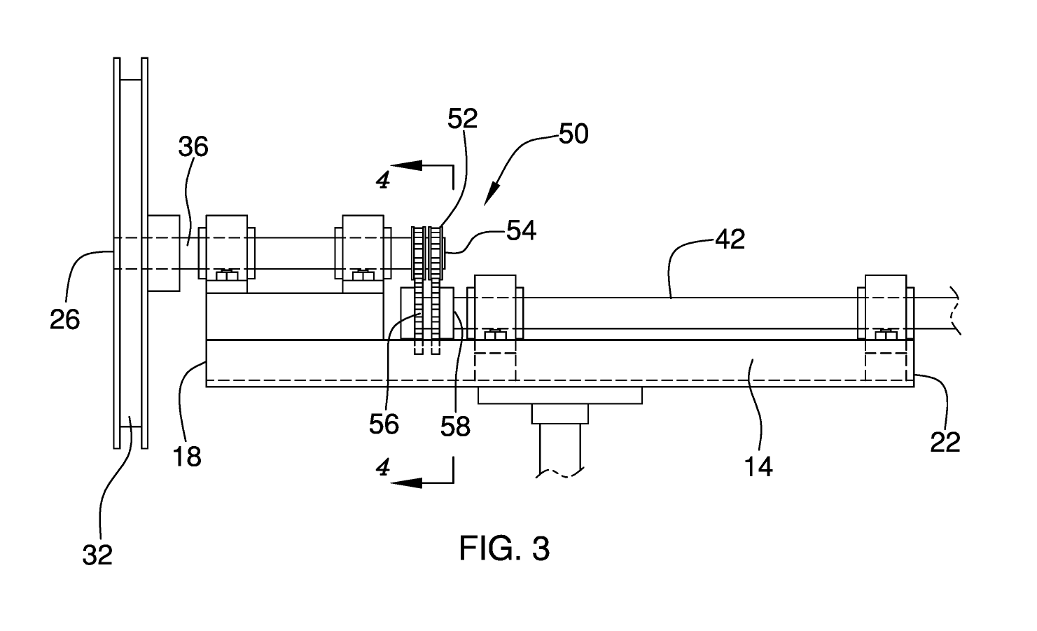

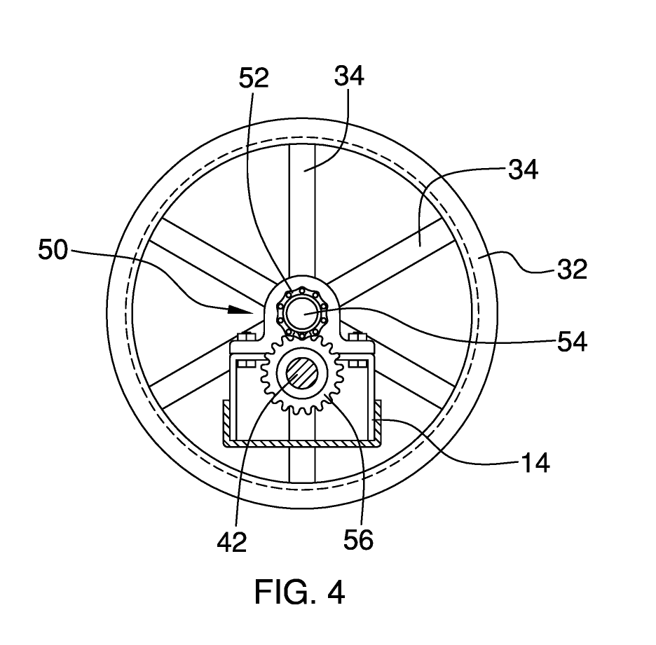

With reference now to the drawings, and in particular to FIGS. 1 through 5 thereof, a new rotation restrictor device embodying the principles and concepts of an embodiment of the disclosure and generally designated by the reference numeral 10 will be described.

As best illustrated in FIGS. 1 through 5, the windmill rotation restrictor device 10 generally comprises a windmill 12 having a base 14. A rotor 16 is coupled to and extends from a first end 18 of the base 14. A vane 20 is coupled to and extends from a second end 22 of the base 14. The windmill 12 includes a stand 24. The base 14 is coupled to the stand 24 wherein the stand 24 elevates the base 14. The base 14 is rotatably coupled to the stand 24. The rotor 16 comprises a rotor hub 26. A front blade assembly 28 includes a plurality of front blades 30. The front blades 30 are arranged to radiate outwardly relative to the rotor hub 26. Each of the front blades 30 is angled such that the front blade assembly 28 is configured to be rotated by wind blowing through the front blade assembly 28. A rotor ring 32 is coupled to the rotor hub 26 by a plurality of spokes 34 such that the rotor hub 26 is centrally positioned relative to the rotor ring 32. Each of the front blades 30 is coupled to and extends radially outward from the rotor ring 32. A front shaft 36 is coupled to the extends from the front blade assembly 28 generally and more particularly by way of attachment and extension from the rotor hub 26. The front shaft 36 couples the front blade assembly 28 to the base 14. The front shaft 36 is freely rotatable relative to the base 14.

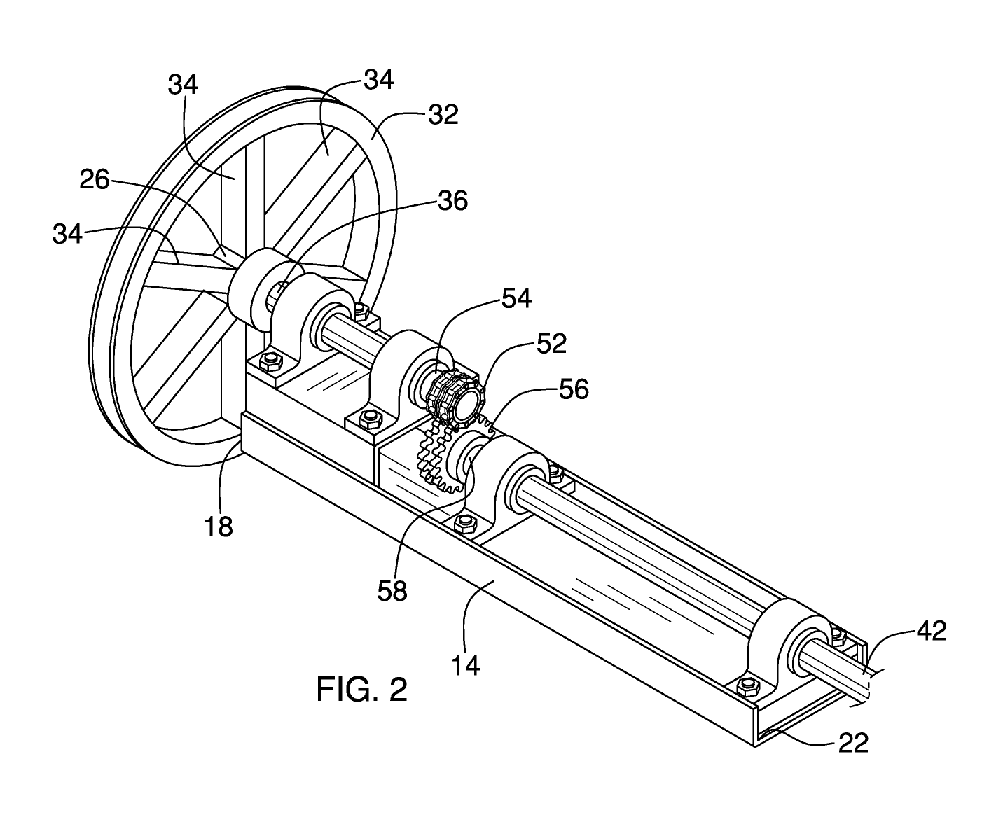

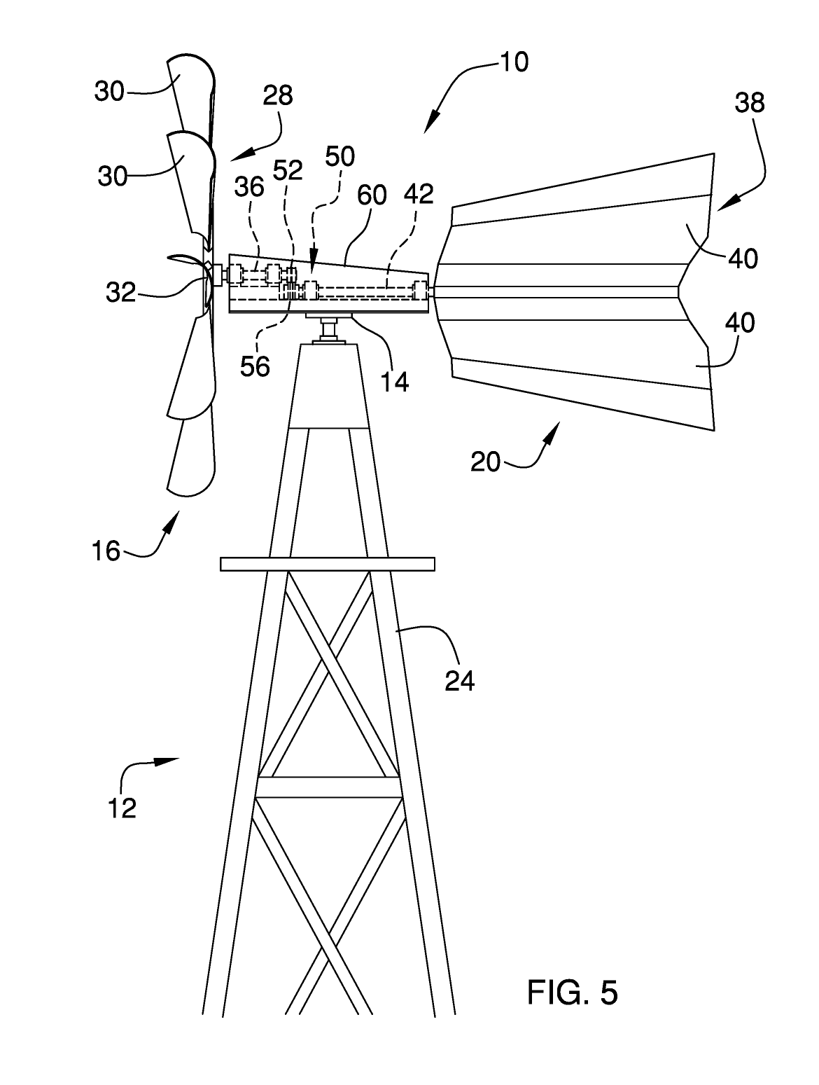

The vane 20 comprises a rear blade assembly 38. The rear blade assembly 38 includes a plurality of rear blades 40. Each of the rear blades 40 has a substantially flat section which is elongated extending away from the base 14 whereby the vane 20 catches the wind and orients the base 14 such that the front blade assembly 28 is configured to face into the wind. A rear shaft 42 is coupled to and extends from the rear blade assembly 38. The rear shaft 42 couples the rear blade assembly 38 to the base 14. The rear shaft 42 is freely rotatable relative to the base 14. The front blade assembly 28 and the rear blade assembly 38 are configured to rotate in opposite directions when blown by wind. A linkage 50 couples the front shaft 36 to the rear shaft 42 such that wind pressure on the rear blade assembly 38 counteracts and slows rotation of the front blade assembly 28. The linkage 50 further includes a front gear 52 coupled to a distal end 54 of the front shaft 36 relative to the front blade assembly 28. A rear gear 56 is coupled to a distal end 58 of the rear shaft 42 relative to the rear blade assembly 38, The rear gear 56 is directly engaged to the front gear 56. The front gear 52 may be a chain type gear and the rear fear 56 may be a toothed gear as shown in FIG. 2. As shown in FIG. 5, a shroud 60 may be removably coupled to the base 14 in a conventional manner such that the shroud 60 extends over and covers the linkage 50.

In use, the windmill 12 is of the generally decorative type wherein function is limited to providing movement to give an indication of wind direction and wind speed. However, the linkage 50 between the rotor 16 and vane 20 effectively restricts rotation speed of the rotor 16 such that the device 12 would give only an indication of high wind speed beyond a threshold wind speed. The windmill 12 is anchored to remain standing in high winds and the restriction of rotation of the rotor 16 serves to prevent damage due to unrestricted high speed rotation.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A decorative windmill rotation restrictor device comprising:
a windmill having a base, a rotor coupled to and extending from a first end of said base, and a vane coupled to and extending from a second of said base;
wherein said rotor comprises
a front blade assembly, said front blade assembly including a plurality of front blades, and
a front shaft coupled to said extending from said front blade assembly, said front shaft coupling said front blade assembly to said base, said front shaft being freely rotatable relative to said base;
wherein said vane comprises
a rear blade assembly, said rear blade assembly including a plurality of rear blades, and
a rear shaft coupled to said and extending from said rear blade assembly, said rear shaft coupling said rear blade assembly to said base, said rear shaft being freely rotatable relative to said base;
wherein said front blade assembly and said rear blade assembly are configured to rotate in opposite directions when blown by wind; and
a linkage coupling said front shaft to said rear shaft such that wind pressure on said rear blade assembly counteracts and slows rotation of said front blade assembly.

2. The device of claim 1, further comprising said windmill including a stand, said base being coupled to said stand wherein said stand elevates said base.

3. The device of claim 2, further comprising said base being rotatably coupled to said stand and said rear blade assembly being elongated extending away from said base whereby said front blade assembly is configured to face into the wind.

4. The device of claim 1, wherein said linkage further comprises:
a front gear coupled to a distal end of said front shaft relative to said front blade assembly; and
a rear gear coupled to a distal end of said rear shaft relative to said rear blade assembly, said rear gear being directly engaged to said front gear.

5. The device of claim 1, further comprising said rotor having a rotor hub, said front blades being arranged to radiate outwardly relative to said rotor hub, each of said front blades being angled such that said front blade assembly is configured to be rotated by wind blowing through said front blade assembly.

6. The device of claim 1, further comprising a shroud, said shroud being couplable to said base such that said shroud extends over and covers said linkage.

7. The device of claim 5, further comprising a rotor ring coupled to said rotor hub by a plurality of spokes such that said rotor hub is centrally positioned relative to said rotor ring, each of said front blades being coupled to and extending radially outward from said rotor ring.

8. A windmill rotation restrictor device comprising:
a windmill having a base, a rotor coupled to and extending from a first end of said base, and a vane coupled to and extending from a second end of said base, said windmill including a stand, said base being coupled to said stand wherein said stand elevates said base, said base being rotatably coupled to said stand;
wherein said rotor comprises
a rotor hub,
a front blade assembly, said front blade assembly including a plurality of front blades, said front blades being arranged to radiate outwardly relative to said rotor hub, each of said front blades being angled such that said front blade assembly is configured to be rotated by wind blowing through said front blade assembly,
a rotor ring coupled to said rotor hub by a plurality of spokes such that said rotor hub is centrally positioned relative to said rotor ring, each of said front blades being coupled to and extending radially outward from said rotor ring, and
a front shaft coupled to said extending from said front blade assembly, said front shaft coupling said front blade assembly to said base, said front shaft being freely rotatable relative to said base;
wherein said vane comprises
a rear blade assembly, said rear blade assembly including a plurality of rear blades, rear blade assembly being elongated extending away from said base whereby said front blade assembly is configured to face into the wind, and
a rear shaft coupled to said and extending from said rear blade assembly, said rear shaft coupling said rear blade assembly to said base, said rear shaft being freely rotatable relative to said base;
wherein said front blade assembly and said rear blade assembly are configured to rotate in opposite directions when blown by wind coming from a single direction;
a linkage coupling said front shaft to said rear shaft such that wind pressure on said rear blade assembly counteracts and slows rotation of said front blade assembly, wherein said linkage further comprises
a front gear coupled to a distal end of said front shaft relative to said front blade assembly; and
a rear gear coupled to a distal end of said rear shaft relative to said rear blade assembly, said rear gear being directly engaged to said front gear; and
a shroud, said shroud being couplable to said base such that said shroud extends over and covers said linkage.
